(19) United States
(12) Patent Application Publication
(10) Pub. No.: US 2010/0050819 A1
(43) Pub. Date: Mar. 4, 2010

(54) Wrench

(75) Inventor: Duck Hyun NAM, Seoul (KR)

Correspondence Address: Jason Y. Pahng and Associates, LLC, 12178 Bridgend Run, Fairfax, VA, 22030, US

(73) Assignee: TAE-JONG DEVELOPMENT CO., LTD., Seoul (KR)

(21) Appl. No.: 12/429,189

(22) Filed: Apr. 24, 2009

(30) Foreign Application Priority Data
Aug. 29, 2008 (KR) 10-2008-0085267
Dec. 15, 2008 (KR) PCT/KR2008/007425
Apr. 8, 2009 (KR) 10-2009-0030499

(51) Int. Cl. B25B 13/46; B25B 13/56

(52) U.S. Cl. 81/60; 81/176.1

(57) ABSTRACT

The present invention provides a wrench that may be simply manufactured at a lower defect rate, which prevents a foreign material from getting stuck in a gap between a ratchet and it's surrounding through hole, and which has a minimal extra space at an end of a first jaw or a second jaw to make it easier for a bolt or a nut to be inserted into the wrench.

### CROSS-REFERENCE TO RELATED PATENT APPLICATION

This application claims the benefit of Korean Patent Application Nos. 10-2004-0030499 and 10-2008-0085267, filed on Apr. 8, 2009 and Aug. 29, 2008, respectively, in the Korean Intellectual Property Office, the disclosure of which is incorporated herein in its entirety by reference. This application also claims the benefit of International Application No. PCT/KR2008/007425, filed on Dec. 15, 2008, in the World Intellectual Property Organization, the disclosure of which is incorporated herein in its entirety by reference.

### BACKGROUND OF THE INVENTION

1. Field of the Invention

The present invention relates to a wrench, and more particularly, to a wrench that is continually turned to tighten a bolt or nut in a particular direction without having to be separated from the bolt or nut.

2. Description of the Related Art

A wrench is a tool that is commonly used to tighten or loosen a bolt or nut when assembling or disassembling mechanical parts. Wrenches, which are also called “spanners”, are classified into an open type and a closed type according to the shape of a head thereof. Open-type wrenches are further classified into a single-ended wrench and a double-ended wrench. In particular, a bolt or nut is tightened as a wrench is turned in one direction and is loosened as the wrench is turned in an opposite direction.

In general, a wrench consists of a handle and a head. For example, as illustrated in FIG. 1, a handle 10 has a shape that can be held by a user. The head 20 includes a base portion 21 that extends from an end of the handle 10, and a first jaw 22 and a second jaw 22′, which extend in parallel from opposite ends of the base portion 21 to face each other.

However, when such a wrench is turned in a direction to tighten or loosen a bolt or a nut, several rotational strokes are needed unless there is a large enough space to allow full rotation of the handle 10 at 360 degrees. The wrench is detached from the bolt or the nut after each rotational stroke and then returned to the initial position so as to be able to apply an additional rotational stroke. This working process is inconvenient.

In order to overcome the inconvenience of having to remove the wrench from the bolt or nut in order to repeatedly apply rotational strokes in a particular direction, a wrench having a flexible ratchet has been developed.

Referring to FIG. 2, a conventional wrench having a extensible and contractable ratchet includes a handle 10a, and a head 20a that includes a base portion 21a extending from an end of the handle 10a, and a first jaw 22a′ and a second jaw 22a that extend in parallel from opposite ends of the base portion 21a. In particular, the wrench further includes a ratchet 24a that is flexibly fit to a slot formed in in the first jaw 22a′ and that is covered by a cover plate 22a″. The ratchet 24 protrudes towards the base portion 21a and compresses a coil spring that is fit into the slot. In addition, the ratchet 24a is flexibly inserted, for example, to be recessed, into the slot to which the coil spring is fit. The cover plate 22a″ is welded to the top and bottom of the slot.

The conventional wrench having the flexible ratchet 24a constructed as described above works smoothly when being turned in a direction in which the ratchet 24a can prevent the bolt or nut from slipping off the wench. As the ratchet 24a that is flexibly fit to the slot tightens the bolt or nut while pushing the bolt or nut, a contact area between the bolt or nut is maximized. A large contact area may be secured even for a worn bolt or nut. As a result, worn bolts or nuts may be effectively tightened or loosened with the wrench. However, the conventional wrench has the following drawbacks.

First, the first jaw 22a′ includes the slot and the cover plate 22a″. However, the dimensional accuracies of these elements may be low if the elements are separately manufactured. In this case, a gap may occur between the second jaw 22a and the cover plate 22a″, and foreign substances may get stuck in the gap.

Second, it is inconvenient to perform an extra process of welding or binding the cover place 22a″ to the top and bottom of the slot. In addition, the external appearance of the wrench may not be aesthetically pleasing.

Third, a minimum space for the cover plate 22a″ to be attached is required in the first jaw 22a′. As the end of the second jaw 22a′ lengthens, a bolt or a nut to be held by the wrench needs to be positioned deep inside the head 20a. However, this may cause the bolt or nut to interfere with the insides of the first jaw 22a′ and the second jaw 22a, thereby making it difficult for the bolt or nut to be positioned deep inside the head 20a.

Fourth, a crack may occur around an edge region of the slot, and the wrench is liable to be broken.

FIG. 3 illustrates another example of a conventional wrench. A reception groove is formed in a first jaw 22b′ of the wrench, extending outwards from the inside of the first jaw 22b′. In addition, a through hole is formed in a second jaw 22b, passing through the second jaw 22b from the inside to the outside. Ratchets 24b′ and 24b are respectively inserted into the reception groove and the through hole in such a manner as to protrude inwards. The ratchets 24b′ and 24b are elastically supported by a spring 25b and a blocking plate 26b. The ratchet 24b inserted into the through hole of the second jaw 22b engages with the circumference of the bolt or nut and tightens the bolt or nut when the wrench holds the bolt or nut and is then turned in one direction. However, as the wrench is turned in an opposite direction, the ratchet 24b slides backwards into the through hole, so that only the wrench is turned while the bolt or nut remains in a fixed state. However, as the ratchet 24b slides backwards, an end of the ratchet 24b may externally protrude out of the through hole.

However, the conventional wrench described above has the following drawbacks.

First, in the conventional wrench, the first jaw 22b′ and the second jaw 22b have the respective ratchets 24b′ and 24b. As a result, the conventional wrench is liable to be broken. When the wrench is turned, a tensile force is exerted on either the first jaw 22b′ or the second jab 22b depending on the rotation direction of the wrench, whereas a compression force is exerted on the other one. In other words, when the wrench is turned clockwise, as illustrated in FIG. 4, a tensile force is exerted on the first jaw 22b′, while a compression force is exerted on the second jaw 22b. Apart from the second jaw 22b on which the compression force is exerted, the first jaw 22b′ is more likely to be broken by an external force. If the first jaw 22b′ has the reception groove, as described above, cracks may occur around the reception groove of the first jaw 22b′ as tightening is repeated.

Second, as the ratchet 24b of the second jaw 22b is slidably pushed outwards by the bolt or nut, the end of the ratchet 24b protrudes outwards, as illustrated in FIG. 4. This may reduce the radius of rotation of the wrench. In other words, when a working space is limited and there is an obstacle around the head of the wrench, the protruding ratchet 24b may interfere with the obstacle, and thus interrupt the rotation of the wrench.

### SUMMARY OF THE INVENTION

The present invention provides a wrench that may be simply manufactured at a lower defect rate, which prevents a foreign material from getting stuck in a gap between a ratchet and it's surrounding through hole, and which has a minimal extra space at an end of a first jaw or a second jaw to make it easier for a bolt or a nut to be inserted into the wrench.

The present invention provides a wrench that prevents cracking in a first jaw or a second jaw due to repeated tightening and that minimizes the interruption of rotation of the wrench by a surrounding obstacle.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional wrench;

FIG. 2 is a perspective view of a conventional wrench including a ratchet;

FIG. 3 is a cross-sectional view of a conventional wrench including a ratchet;

FIG. 4 is a view for explaining the operational mechanism of the wrench of FIG. 3;

FIG. 5 is a cross-sectional view of a wrench according to an embodiment of the present invention;

FIG. 6 is an exploded cross-sectional view of the wrench of FIG. 4;

FIG. 7 is an overall perspective view of the wrench of FIG. 4;

FIG. 8 is a cross-sectional view of a wrench according to another embodiment of the present invention; and

FIG. 9 is a cross-sectional view of a wrench according to another embodiment of the present invention.

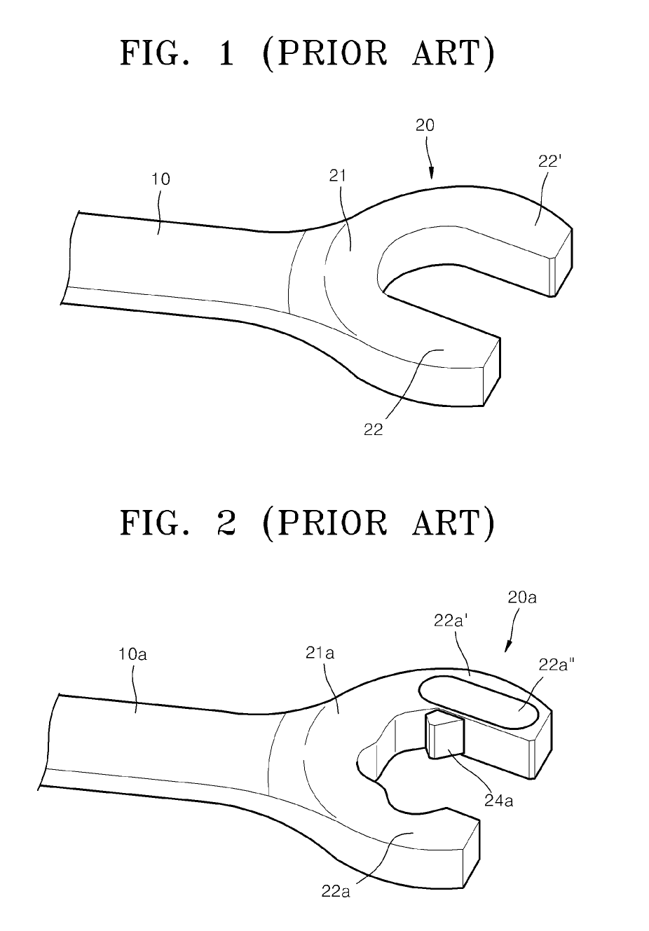

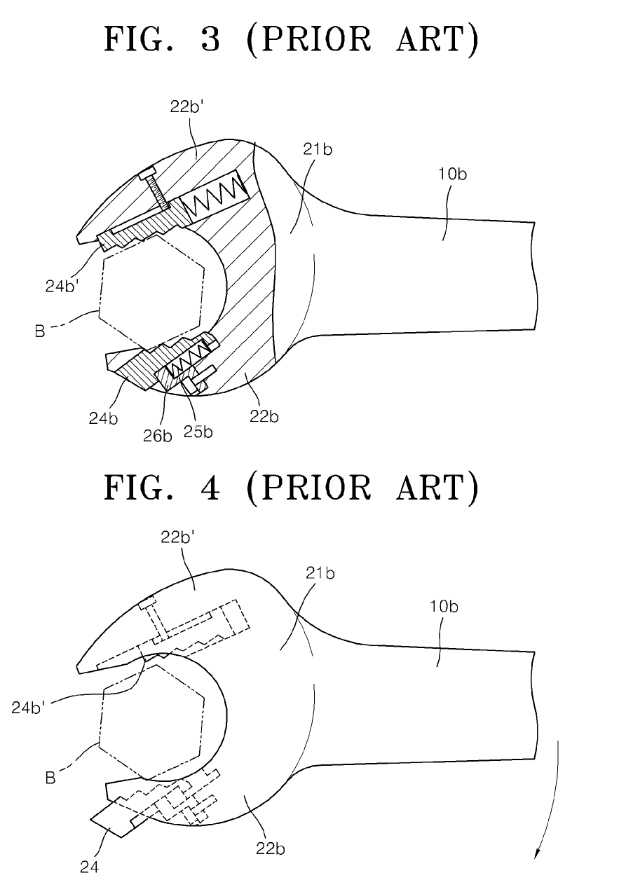

### DETAILED DESCRIPTION OF THE INVENTION

Hereinafter, embodiments of the present invention will be described in detail with reference to the appended drawings.

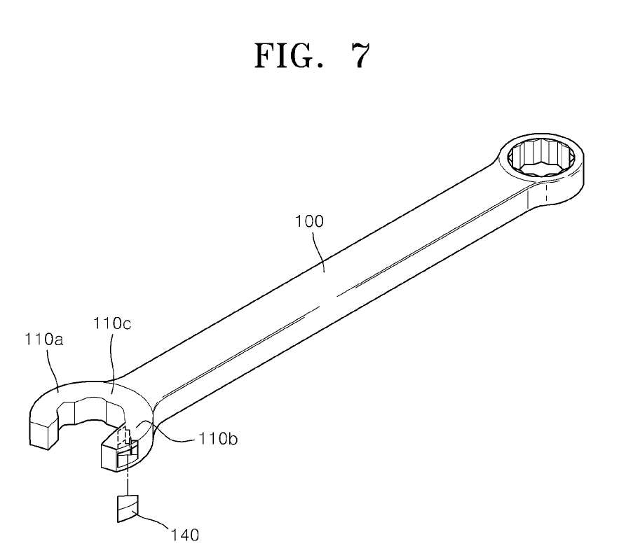

FIGS. 5 through 7 illustrate a wrench having a flexible ratchet according to an embodiment of the present invention.

The wrench according to the present embodiment refers to a tool that may be used to tighten a bolt or nut by being turned in one direction and to loosen the bolt or nut by being turned in the opposite direction. The wrench includes a handle 100, a head 110, a ratchet member 120, an elastic pressure member 130, and a blocking member 140.

The handle 100 has a shape that can be hand-held by a user. The handle 100 may have a bar shape extending in a particular direction. The handle 100 may be formed of a high-hardness, metallic material. However, the handle 100 is not limited to this, and may be formed of various materials.

The head 110 is manufactured as a whole by casting. The head 110 is bound with the handle 100 in a single body, and contacts and holds the bolt or nut. The head 110 has a “C”-shape with an open end. The head 110 includes a base portion 110c, a first jaw 110a, and a second jaw 110b.

The base portion 110c, which is a portion opposite to the open end of the head 110, extends from an end of the handle 100.

The first jaw 110a and the second jaw 110b extend in parallel from opposite ends of the base portion 110 to face each other. The first jaw 110a and the second jaw 110b may have, but are not limited to, symmetrical shapes. The first jaw 110a and the second jaw 110b may have different shapes if required. Together, the first jaw 110a and the second jaw 110b have a circular shape. The base portion 110c, the first jaw 110a and the second jaw 110b engage with a head portion of the bolt or nut as the head portion of the bolt or the nut is received in a space defined inside the base portion 110c, the first jaw 110a, and the second jaw 110b through the open end of the head 110.

A through hole 112b passing through the second jaw 110b from the outside of the second jaw 110b near the end of the second jaw 110b to the inside of the second jaw 110b near the base portion 110c is formed in the second jaw 112b. In particular, the through hole 112b is elongated from the end of the second jaw 112b towards the base portion 110c, which may contact the bolt or nut. Due to the elongated direction of the through hole 112b, the ratchet member 120 may slide from the end of the second jaw 11b towards the base portion 110c as the ratchet member 120 is inserted into the through hole 112b. A stepped portion 111b, which protrudes inwards in the through hole 112b, is formed in a portion of the through hole 112b close to the base portion 110c. The stepped portion 111b has a function of stopping the ratchet member 120 from escaping out of the through hole 112b, which will be described later.

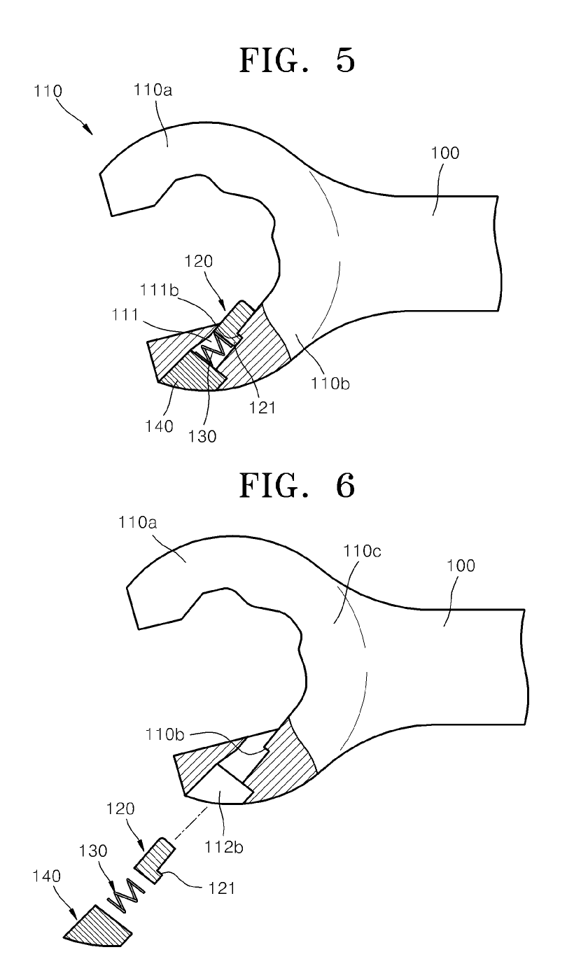

In the present embodiment, the first jaw 110a refers to a portion on which a tensile force is exerted as the wrench is turned in a direction to tighten the bolt or nut, and the second jaw 110b refers to a portion on which a compression force is exerted. The positions of the first jaw 110a and the second jaw 110b, i.e., which one is above or below the other, may differ from the illustrations in FIGS. 5 and 6. In other words, although the first jaw 110a is illustrated to be in an upper position with respect to the second jaw 110b in FIGS. 5 and 6, the positions of the first jaw 110a and second jaw 110b may be switched.

The ratchet member 120 is inserted into the through hole 112b to protrude out of the through hole 112b towards the base portion 110c, so that the ratchet member 120 contacts and engages with the bolt or nut, thereby tightening the bolt or nut. The ratchet member 120 may have a pillar shape with a rectangular cross-section, but is not limited to this, and may have various shapes. A portion of the ratchet member 120 that contacts the head portion of the bolt or nut may have a smooth surface, or may have a toothed surface if needed, in order to prevent slipping on the bolt or nut.

A keeper 121 is formed on a portion of the ratchet member 120 opposite to the portion contacting the head portion of the bolt or nut. The keeper 121 may have a shape corresponding to the shape of the stepped portion 111b of the through hole 112b so that the keeper 121 is engaged with the stepped portion 111b. As the keeper 121 is engaged with the stepped portion 111b, the ratchet member 120 is prevented from escaping out of the through hole 112b. In other words, the ratchet member 120 may only slide within a particular distance range.

The elastic pressure member 130 has a structure for elastically pressing the ratchet member 120 towards the base portion 110c. An end of the elastic pressure member 130 is supported by the blocking member 140, whereas the other end of the elastic pressure member 130 contacts and elastically supports the ratchet member 120. In particular, the elastic pressure member 130 is disposed between the ratchet member 120 and the blocking member 140 to elastically press the ratchet member 120. The elastic pressure member 120 may be a coil spring. However, the elastic pressure member 120 may be any elastic element that is repeatedly compressible and extensible, such as elastic rubber.

The blocking member 140, which blocks an end of the through hole 112, may be formed of various materials that can support an end of the elastic pressure member 130, such as a metallic material or a synthetic resin. The blocking member 140 may be fixedly bound to the through hole 11b by, for example, welding. Alternatively, the blocking member 140 may be fixed to the through hole 112b by tight fitting.

The wrench according to the current embodiment may be assembled as follows. Initially, the head 110 and the handle 100 are formed as a single body of the wrench by casting. Next, the ratchet member 120 is inserted into the through hole 112b. In particular, the ratchet member 120 is inserted into the through hole 112b from the end of the second jaw 110b towards the base portion 110c. Then, the elastic pressure member 130 is inserted into the through hole 112b to contact the ratchet member 120. Finally, the blocking member 140 is tightly fit into the through hole 112b. As a result, the ratchet member 120 may slide towards the base member 110c while being elastically supported in the through hole 112b.

The wrench described above may operate as follows.

When the wrench is turned in a direction in which the ratchet member 120 tightens the bolt or nut, the ratchet member 120 comes in contact with the bolt or nut, and a force driving the ratchet member 120 to move towards the base portion 110c is applied. Herein, the position of the keeper 121 of the ratchet member 120 is fixed by the stepped portion 111b in the through hole 112b, and the ratchet member 120 engages with and tightens the bolt or nut within the space inside the head 110. Meanwhile, when the wrench is turned in the opposite direction, a force driving the ratchet member 120 to move towards the end of the second jaw 110b is applied. If the force is greater than the elastic repelling force of the elastic pressure member 130, the ratchet member 120 may slide towards the end of the second jaw 110b, which allows the wrench to be turned with respect to the bolt or nut. When the wrench is turned again in the initial tightening direction, the bolt or nut is tightened as described above. Thus, while the wrench is turned alternately in opposite directions forwards and backwards, the relative position of the bolt or nut in the head 110 of the wrench may be fixed and the wrench does not have to be separated from the nut or bolt for each turn of alternate direction.

Regarding the wrench according to the current embodiment, the first jaw 110a and the second jaw 110b including the through hole 110b may be manufactured all at the same time as a single body. Thus, it is straightforward to manufacture the wrench on a mass scale, and the manufacturing costs are lowered. Meanwhile, since a conventional method of manufacturing a wrench may involve forming an additional slot in a first jaw and binding a cover plate, which has been previously manufactured, to the slot, the overall manufacturing process is complicated. In addition, a gap may be formed in a portion where the cover plate and the slot are bound unless a skilled worker is involved. Furthermore, a foreign material may get stuck in the gap between the cover plate and the slot. In particular, it is difficult to automate the binding process, and thus to manufacture the wrench on a mass scale.

Meanwhile, according to the current embodiment of the present invention, the ratchet member 120 is installed to slide toward the base portion 110c. This may contribute to miniaturization of the wrench and simplifies the manufacturing process compared to the conventional wrench in which an end of the ratchet 24b protudes out of the through hole towards the end of a jaw, as illustrated in FIG. 4. In addition, in the wretch according to the current embodiment of the present invention, the ratchet member 120 is installed only in the second jaw 110b on which the compression force is exerted. Thus, the wrench according to the current embodiment is more durable than the conventional wrench including a through hole or a groove in a jaw on which the tensile force is exerted. In addition, the wrench according to the current embodiment is designed such that the ratchet member 120 protrudes only towards the base portion 110c, unlike the conventional wrench in which the ratchet 24b protrudes towards the end of the second jaw 22b. Thus, the wrench according to the current embodiment may not interfere with any surrounding obstacles while being turned, and thus may be conveniently used in a working environment that has a limited amount of space.

Unlike the conventional wrench, the wrench according to the current embodiment does not include a cover plate, but has a through hole. As a result, it is unlikely that the tensile strength of the second jaw is reduced and that the second jaw cracks. The appearance of the wrench according to the current embodiment may look fine since it does not include the cover plate. In addition, the wrench may be precisely manufactured by casting, and thus, a foreign material is less likely to get stuck in the gap between the ratchet member 120 and the through hole 112b.

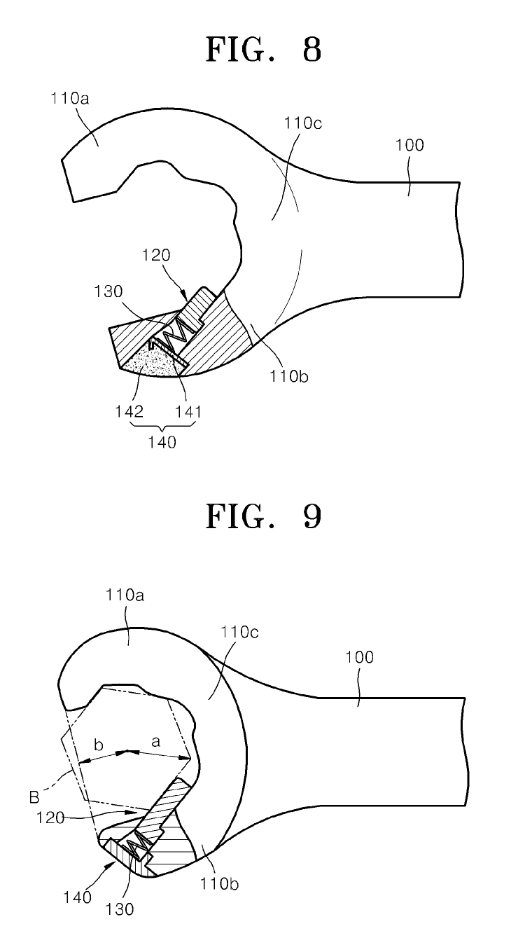

FIG. 8 illustrates a wrench according to another embodiment of the present invention. The wrench according to the current embodiment differs from the previous embodiment in terms of the blocking member. The blocking member 140 of the wrench according to the previous embodiment is formed as a single body and is inserted into the through hole 112b. However, a blocking member 140 according to the current embodiment includes a metal plate 141 and a filler portion 142. The metal plate 141, which has a function to support the elastic pressure member 130, is formed of a metallic steel sheet, such as stainless steel. The metal plate 141 may be fixedly installed within the through hole by tight fitting, welding, or the like.

The filler portion 142, which fills a space between a surface of the metal plate 141 and the end of the second jaw 110b, is formed by filling the space with high-strength polyurethane and curing the filling material. Alternatively, once the space has filled with liquid high-strength polyurethane, the filling material may be cured along with a predetermined metallic pattern such that the pattern appears on the surface of the filler portion 142. As a result, the overall appearance of the wrench may be aesthetically pleasing. For example, the predetermined metallic pattern may be a logo of the manufacturing company.

FIG. 9 illustrates a wrench according to another embodiment of the present invention. In the wrench according to the current embodiment, the first jaw 110a and the second jaw 110b are formed to be shorter than those of the previous embodiments. In particular, the wrench has a shape for keeping hold of a bolt or nut to be tightened within the head 110 of the wrench while being turned in a particular direction. Thus, a user may work more conveniently with the wrench. In particular, the wrench may have a shape such that the shortest distance (b) between a virtual line connecting the end of the first jaw 110a and the end of the second jab 110b and the center of rotation of a bolt or nut held in the head 110 is smaller than the shortest distance (a) between the center of rotation of the bolt or nut and the base portion 110c. Furthermore, the head 110 may have an oval shape. If the head 110 has an oval shape, the open end of the head 110 may be wider, and thus the bolt or nut to be tightened may be positioned deep inside the head 110 upon being inserted into the head 110, in a single direction. In other words, if the lengths of the first jaw 110a and the second jaw 110b are large, as in the previous embodiments, a path to the bolt or nut's final position deep inside the head 110 is narrow and long. Thus, once the bolt or nut to be tightened has be placed within the head 110 in a particular direction, the bolt or nut needs to be further moved in upper and lower diagonal directions until the bolt or nut is in the final position, deep inside the head 110. However, if the head 110 has an oval shape as in the current embodiment, the bolt or nut may be placed in the final position within the head 110 upon being inserted into the head 110 in a single direction.

In addition, according to the current embodiment, the width of the first jaw 110a on which the tensile force is exerted is increased to reinforce the tensile strength of the first jaw 110a. Thus, even if the tensile force is repeatedly applied, the first jaw 110a may not crack, and a crack in the first jaw 110a may not further develop.

Although the present invention is described above with reference to the exemplary embodiments, the present invention may be implemented in various forms as follows.

While the through hole is described as being formed in the first or second jaw by casting in the embodiments described above, the present invention is not limited to the embodiments, and the through hole may be formed by drilling.

In addition, while an end of the through hole receiving the ratchet member is described as being blocked by the stopping member in the embodiments described above, the present invention is not limited to the embodiments, and the end of the through hole may be partially open provided that the through hole is formed in either the first jaw or the second jaw.

Furthermore, while the filler portion is described as being formed of high-strength polyurethane in the previous embodiment, the filler portion may be formed of various materials, such as epoxy resin, provided that it ensures a sufficient tensile strength after being cured.

As described above, a wrench according to the present invention includes a through hole in a jaw passing through from an end of the jaw to an inner portion of the jaw close to the base portion. Thus, unlike the conventional wrench in which the edge portion of a slot formed in a jaw of the wrench may crack and is likely to break, cracking is less likely to occur in the wrench according to the present invention.

In addition, the wrench according to the present invention may be manufactured on a mass scale by, for example, casting. In particular, the wrench may be simply assembled by inserting a ratchet member and an elastic pressure member into the through hole and blocking the through hole with a blocking member.

The overall manufacturing process is simplified, and the accuracy in assembling the wrench is improved, compared to conventional wrenches. In addition, since the ratchet member is installed only in a jaw on which the compression force is exerted, the tensile strength is high, and cracking is less likely to occur.

Furthermore, an end of the ratchet member inserted into the through hole of the wrench according to the present invention protrudes out of the through hole towards the base portion, whereas the opposite end of the ratchet member slides within the through hole. Thus, the ratchet member may not interrupt the rotation of the wrench even when used in a working environment that has a limited amount of space.

Finally, the first jaw and the second jaw of the wrench according to the present invention are shorter than conventional ones, and thus a bolt or nut to be tightened may be positioned deep inside a head of the wrench upon being inserted into the head in a single direction. Thus, it is straightforward to work with the wrench, and the working span is small. Thus, the wrench may be used in various working environments.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wrench that tightens a bolt or nut when turned in one direction and loosens the bolt or nut when turned in an opposite direction, the wrench comprising a handle held by a user, and a head that is bound to the handle and contacts and holds the bolt or nut,
wherein the head comprises a base portion extending from an end of the handle, and a first jaw and a second jaw that extend in parallel from opposite ends of the base portion to face each other,
a through hole is formed in only one of the first jaw and the second jaw, passing through one of the first jaw and the second jaw from an outer end portion thereof to an inner portion thereof close to the base portion,
a ratchet member protruding out of the through hole towards the base portion and sliding within the through hole, and
an elastic pressure member that elastically presses the ratchet member towards the base portion, wherein the ratchet member and the elastic pressure member are disposed in the through hole.

2. The wrench of claim 1, wherein an end of the elastic pressure member is supported by a blocking member, and another end of the elastic pressure member contacts and elastically presses the ratchet member.

3. The wrench of claim 1, wherein, when the wrench is turned in the one direction, a compression force is exerted on one of the first jaw and the second jaw, while a tensile force is exerted on the other one, and the through hole is formed in one of the first jaw and the second jaw on which the compression force is exerted.

4. A wrench that tightens a bolt or nut when turned in one direction and loosens the bolt or nut when turned in an opposite direction, the wrench comprising a handle held by a user, and a head that is bound to the handle and contacts and holds the bolt or nut,
wherein the head comprises a base portion extending from an end of the handle, and a first jaw and a second jaw that extend in parallel from opposite ends of the base portion to face each other,
the first jaw and the second jaw being formed as a complete single body, and
a ratchet member sliding between an outer portion of only one of the first jaw and the second jaw and the base portion, and protruding through an inner portion thereof close to the base portion so as to contact the bolt or nut held within the head, and
an elastic pressure member that elastically presses the ratchet member towards the base portion, wherein the ratchet member and the elastic pressure member are disposed in only one of the first jaw and the second jaw.

5. The wrench of claim 4, wherein a through hole is formed in only one of the first jaw and the second jaw, passing through only one of the first jaw and the second jaw from an outer end portion thereof to an inner portion thereof close to the base portion, and
a blocking member blocking the outer end portion of only one of the first jaw and the second jaw,
an elastic pressure member being supported by the blocking member, and
the ratchet member being elastically pressed by the elastic pressure member, wherein the blocking member, the elastic pressumer member, and the ratchet member are disposed in the through hole.

6. The wrench of claim 5, wherein the blocking member comprises a metal plate having a surface in contact with the elastic pressure member, the metal plate being fixedly installed in the through hole, and a filler portion filling a space in the through hole between another surface of the metal plate and the outer end portion of only one of the first and the second jaw.

7. The wrench of claim 5, wherein the filler portion comprises high-strength polyurethane.

8. The wrench of claim 1, wherein the first jaw and the second jaw have a shape for keeping hold of the bolt or nut to be tightened as the bolt or nut is inserted in a single direction.

9. The wrench of claim 8, wherein the first jaw and the second jaw have a shape in which the shortest distance between a virtual line connecting an end of the first jaw and an end of the second jaw and the center of rotation of the bolt or nut held in the head is smaller than the shortest distance between the center of rotation of the bolt or nut and the base portion.

10. A wrench that tightens a bolt or nut when turned in one direction and loosens the bolt or nut when turned in an opposite direction, the wrench comprising a handle held by a user, and a head that is bound to the handle and contacts and holds the bolt or nut,
wherein the head comprises a base portion extending from an end of the handle, and a first jaw and a second jaw that extend in parallel from opposite ends of the base portion to face each other,
a ratchet member sliding between an outer end portion of only one of the first jaw and the second jaw and the base portion, and protruding through an inner portion thereof close to the base portion so as to contact the bolt or nut held within the head, and an elastic pressure member that elastically presses the ratchet member towards the base portion are disposed in only one of the first jaw and the second jaw, and
wherein the first jaw and the second jaw have a shape in which the shortest distance between a virtual line connecting an end of the first jaw and an end of the second jaw and the center of rotation of the bolt or nut held in the head is smaller than the shortest distance between the center of rotation of the bolt or nut and the base portion.

11. The wrench of claim 10, wherein a through hole is formed in only one of the first jaw and the second jaw, passing through only one of the first jaw and the second jaw from an outer end portion thereof to an inner portion thereof close to the base portion, and
a blocking member blocking the outer end portion of only one of the first jaw and the second jaw, an elastic pressure member being supported by the blocking member, and the ratchet member being elastically pressed by the elastic pressure member, are disposed in the through hole.

12. The wrench of claim 6, wherein the first jaw and the second jaw have a shape for keeping hold of the bolt or nut to be tightened as the bolt or nut is inserted in a single direction.

13. The wrench of claim 12, wherein the first jaw and the second jaw have a shape in which the shortest distance between a virtual line connecting an end of the first jaw and an end of the second jaw and the center of rotation of the bolt or nut held in the head is smaller than the shortest distance between the center of rotation of the bolt or nut and the base portion.
